(19) United States
(12) Patent Application Publication
(10) Pub. No.: US 2017/0356125 A1
(43) Pub. Date: Dec. 14, 2017

(54) METHOD FOR CUTTING OBJECTS OUT OF AN AT LEAST PARTIALLY TWO-PLY WEB OF MATERIAL BY MEANS OF A CUTTING DEVICE

(71) Applicant: GUNNAR HELD, HEUSENSTAMM (DE)

(72) Inventor: GUNNAR HELD, HEUSENSTAMM (DE)

(21) Appl. No.: 15/521,017

(22) PCT Filed: Nov. 10, 2015
(86) PCT No.: PCT/EP2015/002252

§ 371 Date: Apr. 21, 2017

(30) Foreign Application Priority Data
Nov. 27, 2014 (DE) 10 2014 017 501.4

(51) Int. Cl. D06H 7/24; B26F 1/44; B23K 26/03; B26D 5/00

(52) U.S. Cl. CPC D06H 7/24; B26D 5/007; B26D 5/005; B26F 1/44; B23K 26/03

(57) ABSTRACT

Method for cutting objects out of an at least partially two-ply web of material by means of a cutting device, wherein two material plies are connected to one another at least partially in a linear, strip-like and/or areal manner. The position of the respective object to be cut out is detected contactlessly on the basis of changes in structure in the material, these being part of the object which arise on account of those regions in the web of material which are connected to one another in a linear, strip-like and/or areal manner. The position of the object is detected in the web of material at least on the basis of previously determined and stored, prominent and spaced-apart geometrical part shapes of those regions of the object which are connected to one another in a linear, strip-like and/or areal manner.

### BACKGROUND OF THE INVENTION

The present invention relates to a method for cutting objects out of an at least in part two-layered web of material using a cutting device.

The method is in particular intended to cut pouch or bag-shaped objects, which includes pre-cuts for airbags, out of such a two-layered material web. The method is preferably used in connection with a laser cutting device.

Such a material web from which the objects are to be cut out is made of at least two material layers, which are at least in the circumferential areas of by the respective object to be cut out partially bonded to each other in the shape of lines, strips and/or an area. This connection can be made of an adhesion bond of the two material webs, a welding bond of the two material webs or an interwoven bond of the two material webs. An interwoven bond of the two material webs is used in particular for the manufacture of airbag pre-cuts.

In some applications, as is also the case in the manufacture of airbags, the parts must be cut out very precisely in order to meet all safety-relevant aspects for durability of the airbags when they are used and unfold under high pressure. Especially the two interwoven or stitch-bonded areas of the two material layers of the material webs must not be damaged and thus weakened when cutting the airbag pre-cut out of the material web. Exempted from this are interwoven or stitch-bonded areas that form the retaining eyes or retaining straps of the airbag, which receive their final shape when cutting out the airbag. Finally, the airbag must be cut out precisely according to specifications.

One problem that exists when cutting out objects from a material web, and in particular a two-layered material web, is that the material webs show a distortion due to the manufacturing process and based on the material and its handling, which can be very different both from one material web to the next and even within a material web. If the objects are cut out using fixed cutting data specified in the cutting device and in relation to the cutting table of the cutting system, then the objects are not cut along their contours specified for the material web due to the distortion in the material web.

To detect such a distortion in a material web, markings with a fixed correlation to the objects to be cut out were provided in the material web. Such markings are detected optically in the cutting device in order to determine the extent of the material web distortion from their positions in the material web. Correction values are derived from the deviations between the nominal positions that correspond to the positions of the markings during the material web production and the actual positions of the markings in the area of the cutting device. The cutting coordinates for cutting out the objects are corrected based on these correction values such that the objects are cut out precisely along the specified contours despite the distortion of the material web.

Recurring patterns, for example, formed by lines extending longitudinally and transversely along the material web, or dots or crosses, which can be recognized on the top of the material web serve as markings. If it is a woven or stitch-bonded material web, identification threads or marking threads that contrast the color of the material web are worked into the material.

Usually, the markings are detected optically, i.e., contact free and the position of the objects in the material web is derived from the positions of the markings, which are then associated with the coordinates of a cutting device as the cutting coordinates. The respective object is cut out based on the cutting coordinates using the cutting device.

The above procedure presupposes that in any case the two- or multilayer material web must be provided with the markings beforehand, which must be printed on at least one side of the material web or in case of a woven or knitted material web, must be worked into it as identification threads. If failures such as irregularities occur when printing onto the material web or when working in the identification threads, precise correlation of the objects to be cut out to these markings is not possible, resulting in rejects. Aside from that, printing onto the material web or working in the identification threads is connected with additional effort and thus with additional costs when manufacturing the objects.

### SUMMARY OF THE INVENTION

The principal objective of the present invention is to provide a method of the type described above which allows for cutting out objects from an at least two-layer material web precise to the location without having to mark the material web beforehand

This objective, as well as other objectives that will become apparent from the discussion that follows, are achieved, in accordance with the present invention, by providing a method in which the position of the respective object to be cut out is detected contact free based on structural changes in the material, which are part of the object, which arise as a result of those areas in the material web that are bonded together in the shape of lines, strips and/or an area. The position of the object in the material web is detected at least on the basis of previously defined and stored, distinct, spaced apart partial shapes of the areas of the object that are connected to each other in the shape of lines, strips and/or an area. Thus, at least a portion of the structures in the material web resulting from areas that are connected to each other is used to recognize the distortion and contortion of the object in the material web due to the distortion of the material web. A special advantage of the method according to the invention is that it is not necessary to detect the entire geometric shape of the object or all surface areas, where the connected structures of the two material webs are located, although it would be possible, of course; however, this would unnecessarily increase the computational effort for converting the detected coordinates to the cutting coordinates.

Preferably, only partial shapes of the connected structures are detected and after detection these partial shapes are connected to each other or supplemented based on the stored geometric shapes of the object. The partial geometric shape of the object that is associated with the connected structures of the two material webs is specified beforehand. The partial shapes are in particular such shapes that are particularly distinct based on their geometry. Such distinct partial shapes may be areas having strongly curved contours, strap-like formations, for example, regardless of whether these distinct geometric shapes are located in the area of the outer contour or in the area of an inner area of the object to be cut out.

These distinct geometric shapes may already be sufficient for deriving the actual position of the object in the material web when it is on the cutting table in order to then cut out the object using the corrected cutting data according to the existing distortion in the material web.

As already mentioned, the distinct partial shapes can be supplemented based on stored geometry and contour data of the object in order to then determine the position of the respective object for the cutting procedures based on the supplemented geometric shapes of the respective object and then associate the cutting coordinates according to the position of the object and then to cut out the object using the cutting coordinates.

Contact free detection of structural changes in the material is done preferably using at least one photographic device. This method has an advantage especially when woven or stitch-bonded structures are to be detected in the area in which both material webs are bonded. Especially when the photographic device is placed at a relatively large distance above the material web, which means at a distance of up to 1500 mm, preferably of about 800 to 1000 mm, the resultant photographic images detect the woven and stitch-bonded structures that are to be detected at a high resolution.

Multiple individual images can be combined to a total image from which the structural changes in the material are detected across a large surface area of the material web. These individual images form a kind of panoramic image, wherein the individual images can also be combined two-dimensionally in rows and lines.

The material web is illuminated to enhance the contrast with which the interconnected areas of the two material webs become apparent. As a result, the structural changes emerge even more clearly. The illumination can be from the top side from which also the photographic images are shot. However, it is also provided, and in certain applications preferred that the material web is trans-illuminated for the contact free detection of the structural changes in the material, preferably from the side of the material web opposite of a photographic device, usually from the bottom side of the material web.

It is also provided to let the material web run through a scanning device on the inlet side of the cutting device and arranged at a small distance from the material web where it performs a scan of the material web's surface or scans the contrast arising when trans-illuminating the material web, preferably from the opposite side. Such a scanning device is arranged in a fixed correlation to the cutting table or to the cutting coordinates of the cutting device such that a distortion in the material web and thus an actual position of the areas, at least partial shapes, of the object connected in the shape of lines, strips and/or an area are detected and the coordinates are transferred to the coordinates of the cutting device.

The presented method also allows for structural changes in the material that are not associated with the parts of the object to be cut out, where, for example, the two material layers are connected to each other in the shape of lines, strips and/or an area, can be detected and the changes checked for potential material faults. If the material fault is associated with the area of an object to be cut out, the object will be examined and a decision will be made whether this material fault concerns only an optical aspect for the object to be cut out or another aspect, for example a safety-relevant aspect that cannot be accepted. The object recognized as faulty will then not be cut out of the material web.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a flow diagram, designated as the main program, that presents the individual steps of the method according to the invention.

FIG. 2 is a sub-program that is integrated in the main program of FIG. 1.

FIGS. 3A to 3C show an object that is to be cut out from a material web, in three steps of the method that are correlated to the flow diagram of FIG. 1.

FIG. 4 is a cutting device that can be used for carrying out the method according to the invention.

FIG. 5A is a schematic presentation of a material web with multiple objects that become apparent in the material web through structural changes in the material.

FIG. 5B shows the objects of FIG. 5A as they are cut out by the device of FIG. 4.

### DESCRIPTION OF THE PREFERRED EMBODIMENTS

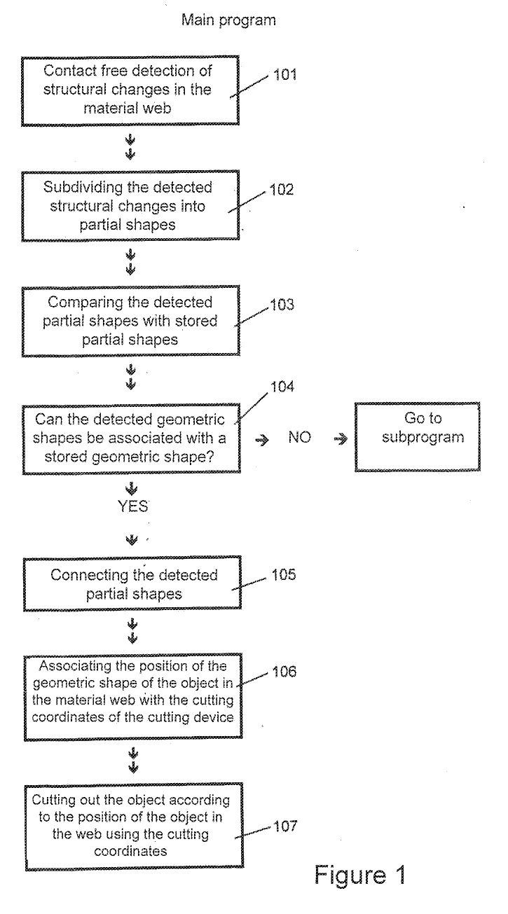

The preferred embodiments of the present invention will now be described with reference to FIGS. 1-5B of the drawings. Identical elements in the various figures are designated with the same reference numerals.

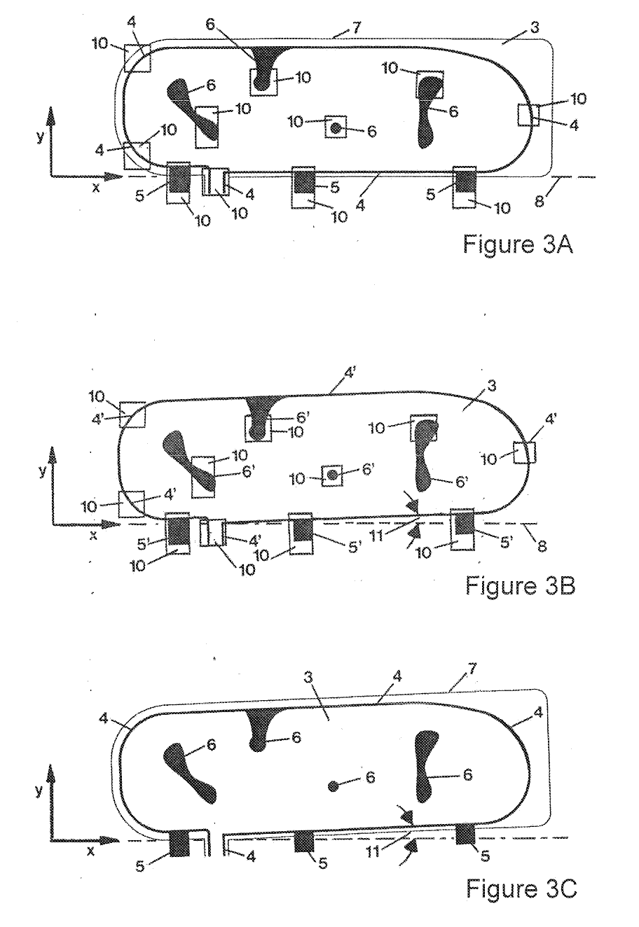

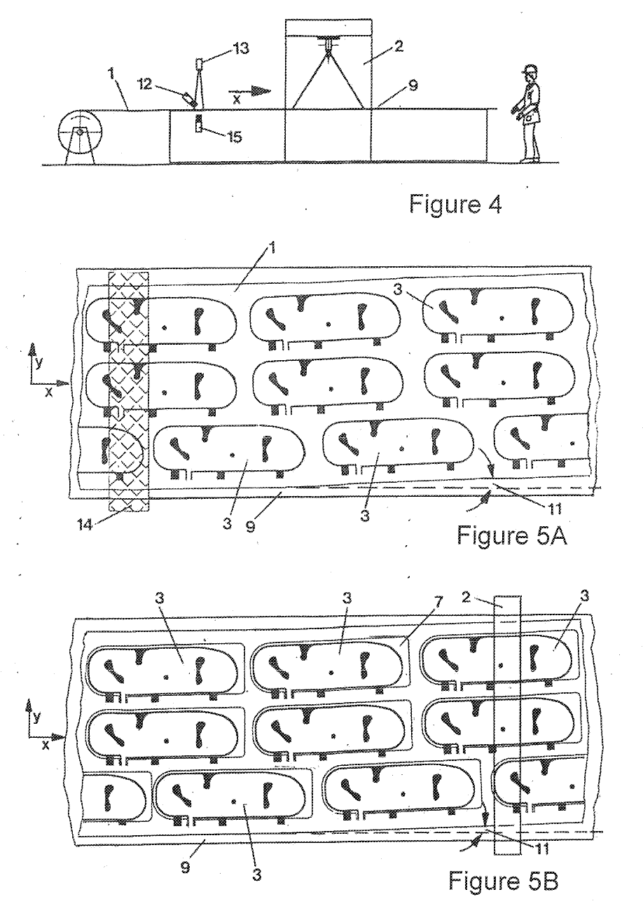

The method according to the invention refers to cutting out objects from an at least two-layer material web 1 as shown in FIGS. 5A and 5B, using a cutting device that is designated with the reference sign 2 in FIGS. 4 and 5B. These material webs 1 have at least two material layers that at least in the circumferential areas of an object 3 to be cut out are partially bonded to each other in the shape of lines, strips and/or an area. Such objects can be pouches, sacks, bags but also more complex parts such as airbags, for example. Such an object 3 in the form of an airbag is presented in FIG. 3A and its manufacture is described below based on the figures.

Usually, these airbags, below all designated with the reference sign 3, are manufactured of a woven or stitch-bonded material web, that consists of at least two material layers placed on top of each other are interwoven or stitch-bonded to each other in partial areas. These woven or stitch-bonded areas of the airbag are presented in FIGS. 3A to 3C by the black areas. These black areas form in part a frame-shaped structure designated with the reference sign 4, strap-shaped sections that are in part connected to the frame-shaped structure 4 and are designated with the reference sign 5, as well as island-shaped sections inside the frame-shaped structure 4 designated with the reference sign 6. At least the frame-shaped structure 4 is located within an outer contour line 7 of the airbag 3, along which the airbag is to be cut out from the material web 1.

Ideally, the connected structures of the material web 1 are oriented in the x-y-direction of a rectangular coordinate system such as is indicated in FIG. 3A, also by the broken line 8. However, it has been demonstrated that the material web 1 shows a distortion or contortion for different, e.g., manufacturing-related, reasons when it runs across the cutting table 9, which can manifest itself as a elongation or shrinkage in the x- and/or y-direction. Such a distortion can be recognized clearly in FIG. 5A.

In order to cut out the airbags 3 using the cutting device 2 in spite of the changed location due to the distortion of the material web 1, this distortion must be taken into account since otherwise there is the risk that the airbag 3 is not cut out along the outer contour line 7 and as a result damage of the safety-relevant woven or stitch-bonded structures 4 and 5 in the area of the airbag's 3 outer contour can occur. Exempted from this are the strap-shaped sections 5, which serve among other things to fasten the airbag in a vehicle; these strap-shaped sections 5 in the region of which the two material layers of the material web 1 are interwoven or stitch-bonded together can be brought to their final form when cutting out the airbag 3.

The method according to the invention, whose sequence is presented in the flow diagram of FIG. 1, is applied for the reasons mentioned above.

Based on the method according to the invention, the position of the airbag 3 in the material web 1 is determined using contact free detection of structural changes in the material web 1, as is indicated in step 101. Such structural changes in the material web 1 arise based on weaving or stitch-bonding structures that are visible on the surface of the material web 1 in the area of which the two material layers of the material web 1 are interwoven or stitch-bonded together. Such structural changes could also arise due to such areas of the material web 1 where two material layers are glued together or bonded to each other in another manner.

The shape of the objects 3 to be cut out, i.e., in the present case the airbags to be cut out, with all contour data and structuring, for example the frame-shaped structure 4, the strap-shaped sections 5, the island-shaped sections 6 and the outer contour line 7, which are specified, are subdivided into partial shapes in a step 102. In FIGS. 3A and 3B such partial shapes are marked by rectangles 10. Preferably such geometric areas of the airbag 3 are selected as partial shapes 10 that are particularly distinct; this includes, for example, the strap-shaped sections 5, the island-shaped sections 6, or at least portions thereof, as well as the frame-shaped structure 4, which have a small curvature radius.

Based on the x-y coordinates and the broken line 8, it is indicated as an example that structures visible in the material web are offset due to the areas of the material layers that are connected to each other compared to the ideal position data of FIG. 3a by an angle 11 due to the distortion of the material web 1 along the cutting table 9 to the x-axis (see also FIG. 5a). A distortion also occurs relative to the y-axis, which, however, is not shown.

Thus, in step 103 a comparison is made between the position of the detected partial shapes designated in FIG. 3B with the reference signs 4, 5 or 6, supplemented with a superscript line, and the stored partial shapes 4, 5 or 6 (see FIG. 3A).

In step 104, a determination is made whether the detected partial shapes 4′, 5′ or 6′ can be associated with a stored geometric shape or stored partial shapes 4, 5, 6. If this is the case, the detected partial shapes 10 (4′, 5′, 6′) are connected to each other mathematically based on stored data of the airbag structure in a step 105.

It should be pointed out that preferably only a portion of the partial shapes of the airbag 3 or the structures 4′ and of the strap-shaped and island-shaped sections 5′, 6′ are detected and are designated using a rectangle 10 in order to keep the computational effort for determining the position of the airbag 3 in the distorted material web 3 low. However, it is also possible to detect the structure lines that stand out in the structure of the material web 1 in their entirety and to determine their position in the material web 1.

In step 106, the position of the geometric shape of the object in the material web 1 is associated with the cutting coordinates of the cutting device 2, and in step 107, the respective object is cut out according to the position of the object in the material web 1 with the cutting coordinates, for the airbags presented in the figures along the outer contour lines 7, which can be determined based on the stored data of the airbag cutout (see FIG. 3A), as is shown in FIG. 3C.

For a contact free detection of the structural changes in the material web 1, a camera system 12 is arranged at the inlet side of the material web 1 into the cutting device 2, in addition, the material web 1 is illuminated perpendicular (y-direction) to the running direction (x-direction) using a suitable light source 13 from above in area 14 marked in FIG. 5A; however, it is also possible as an alternative or in addition to illuminate the material web 1 using a light source 15 from below 1, on the opposite side of the camera system 12, such that a better contrast between light and dark areas can be detected by the camera system 12.

While FIGS. 3B and 3C show the detection of the position of one single airbag in the material web, FIGS. 5A and 5B show the material web 1 with a multitude of airbags 3 to be detected and cut out distributed across its length and width.

The camera system 12 can detect a larger area of the material web 1 by combining several individual images to a total image in order to detect structural changes in the material web 1.

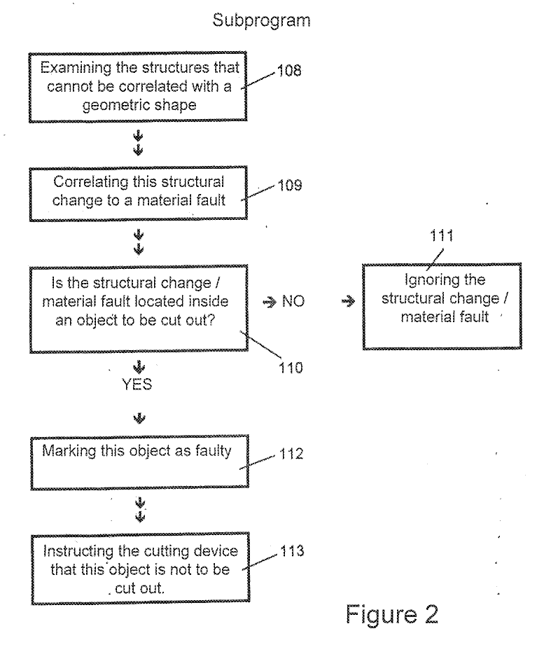

It is possible that step 104 of the flow diagram, which is presented in FIG. 1, results in that detected partial shapes 10 cannot be associated with a stored geometric shape or partial shape. If this is the case, the main program of FIG. 1 branches to a subprogram shown in FIG. 2.

In the subprogram, the structural change that cannot be associated with a geometric shape or a partial shape is examined in a step 108 in order to determine, as shown in step 109, if this structural change can be associated with a material fault and if this structural change/material fault is located inside of an object 3 that is to be cut out (step 110). If this structural change/material fault is not located inside an object 3 to be cut out, this structural change/material fault is ignored (step 111) since being located outside the object 3 to be cut out, it has no influence on the object 3 to be cut out.

If it is determined in step 110 that the structural change/material fault is located inside the object 3 to be cut out, this object is marked as faulty in step 112, and step 113 the cutting device is instructed to not cut this object out since it is faulty in order to save operating time of the machine.

There has thus been shown and described a novel method for cutting objects out of an at least partially two-ply web of material by means of a cutting device which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method for cutting objects out of an, at least in part, two-layered web of material using a cutting device, where at least two material layers are bonded together at least in the circumferential areas of the object to be cut out, in part, in the shape of lines, strips and/or an area, wherein initially data that are associated with the location of the object in the material web are determined remotely and these data are associated with a cutting device as the cutting coordinates, and wherein the respective object is cut out based on the cutting coordinates using the cutting device, the improvement wherein the position of the respective object to be cut out is detected based on structural changes in the material, which are part of the object, that arise based on those areas in the material web that are bonded to each other in the shape of lines, strips and/or an area, and wherein the detection of the position of the object in the material web is carried out based on previously specified and stored distinct, spaced apart partial shapes of the shapes of the areas of the object that are bonded to each other in the shape of lines, strips and/or an area.

2. The method as in claim 1, wherein the partial shapes are connected to each other and/or supplemented after detection based on the stored geometric shape of the object.

3. The method as in claim 2, wherein the position of the respective object in the material web is determined from the supplemented geometric shape of the respective object for the cutting procedure in order to subsequently associate the cutting coordinates according to the position of the object and to cut out the object using the cutting coordinates.

4. The method as in claim 1, wherein the contact free detection of the structural changes in the material is carried out using at least one photographic device.

5. The method as in claim 1, wherein the structural changes in the material are detected from several individual images that are combined to a total image.

6. The method as in claim 1, wherein the material web is illuminated for the contact free detection of the structural changes in the material.

7. The method as in claim 1, wherein the material web is transilluminated for the contact free detection of the structural changes in the material.

8. The method as in claim 1, wherein structural changes in the material that are detected and are not associated with portions of the object to be cut out, where two material layers are bonded with each other in the shape of lines, strips and/or an area are examined as potential material faults.

9. The method as in claim 8, wherein objects with an associated material fault are not cut out from the material web.
